(19) United States
(12) Patent Application Publication
(10) Pub. No.: US 2015/0109958 A1
(43) Pub. Date: Apr. 23, 2015

(54) TRANSMISSION PATH CONTROL DEVICE

(71) Applicant: POWER-ALL NETWORKS LIMITED, Shatin (HK)

(72) Inventors: KAI ZHOU, Wuhan (CN); HAI-TAO LI, Wuhan (CN); MAO-HUA HE, Wuhan (CN)

(21) Appl. No.: 14/511,808

(22) Filed: Oct. 10, 2014

(30) Foreign Application Priority Data
Oct. 18, 2013 (CN) 201310490079.6

(51) Int. Cl. H04L 12/755; H04L 12/713; H04L 12/751

(52) U.S. Cl. CPC H04L 45/021; H04L 45/10; H04L 45/586
USPC 370/254

(57) ABSTRACT

A transmission path control device is connected to a management server and a router device located on the same area as the transmission path control device. The transmission path control device determines whether a corresponding router device has a port directed to an end area when receiving a virtual lease line (VLL) establishing request including a start area and the end area of the VLL. If not, the transmission path control device transmits the VLL establishing request to a default transmission path control device. If yes, the transmission path control device determines which router devices are transmission nodes constituting the VLL and determines which ports are ports to be connected. The transmission path control device further connect the ports used to connect one by one, thus to establish the VLL.

### CROSS-REFERENCE TO RELATED APPLICATIONS

This application claims priority to Chinese Patent Application No. 201310490079.6 filed on Oct. 18, 2013 in the China Intellectual Property Office, the contents of which are incorporated by reference herein. This application is related to the following co-pending, commonly assigned patent applications, the disclosures of which are incorporated herein by reference in their entirety:
1. “NETWORK SYSTEM CAPABLE OF ENHANCING CONNECTION PERFORMANCE” by Zhou et al., whose Attorney Docket No is US53458.
2. “TRANSMISSION PATH MANAGEMENT SYSTEM AND METHOD” by Zhou et al., whose Attorney Docket No is US53457.
3. “TRANSMISSION PATH MANAGEMENT SYSTEM AND METHOD” by Zhou et al., whose Attorney Docket No is US53456.
4. “TRANSMISSION PATH CONTROL SYSTEM” by Zhou et al., whose Attorney Docket No is US53443.
5. “TRANSMISSION PATH MANAGEMENT DEVICE” by Zhou et al., whose Attorney Docket No is US53453.
6. “ON-DEMAND TRANSMISSION PATH PROVIDING SYSTEM AND METHOD” by Zhou et al., whose Attorney Docket No is US53455.

### FIELD

The present disclosure relates to control devices, and particularly to a transmission path control device.

### BACKGROUND

Nowadays, people located distant from each other can communicate via networks, such as Internet. For example, people can connect to the networks using various electronic devices, thus to communicate with each other. Generally, when a user accesses a target object provided by a server far away from the user, a transmission path that is randomly generated to access the target object maybe complex and may cause a long delay time.

### BRIEF DESCRIPTION OF THE DRAWINGS

Implementations of the present technology will now be described, by way of example only, with reference to the attached figures.

FIG. 1 is a diagrammatic view of a number of transmission path control device connected to a management server and corresponding router devices.

FIG. 2 is a block diagram of a transmission path control device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

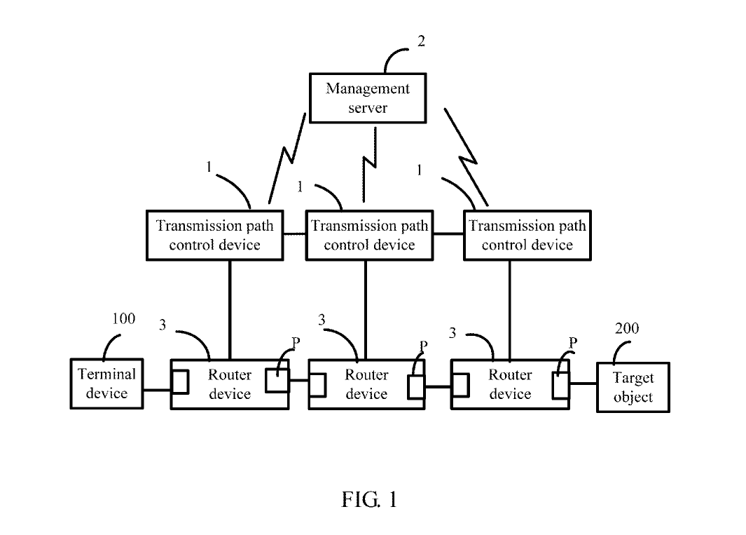

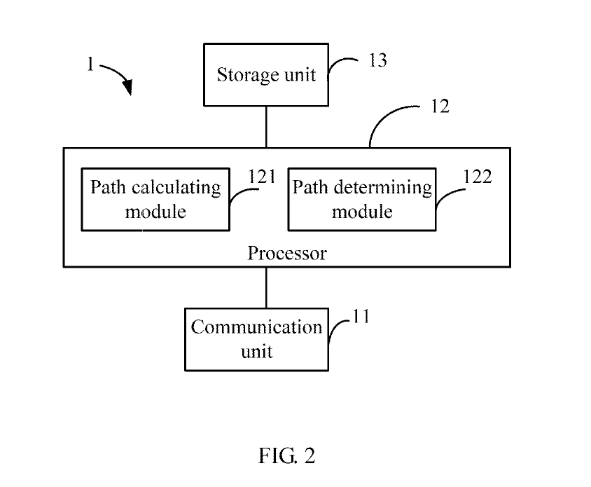

Referring to FIGS. 1 and 2, a number of transmission path control devices 1 are illustrated. Each transmission path control device 1 is connected to a management server 2 and a router device 3. Each transmission path control device 1 is located in a corresponding area, specially, located in a corresponding geographic area, and is connected to one router device 3 located in the same area. The transmission path control device 1 is also connected to at least one another transmission path control device 1 and the management server 2 via corresponding networks. The network can be Internet, a wireless network including WIFI and BLUETOOTH, a telecommunication network including a general packet radio service (GPRS) network and a code division multiple access (CDMA) network, or a broadcasting network, for example. The network between the transmission path control device 1 and the at least one another transmission path control device 1 and the network between the transmission path control device 1 and the management server 2 can be the same or the different.

In the embodiment, each transmission path control device 1 and the corresponding router device 3 located in the same area are located in an Internet Data Center (IDC). For example, one transmission path control device 1 and the corresponding router device 3 are located in the IDC of New York, another transmission path control device 1 and the corresponding router device 3 are located in the IDC of Philadelphia. The IDC can be a computing network constituted by a number of computing devices.

In the embodiment, the transmission path control device 1 can be a personal computer, a server, or the like. The management server 2 can be a server or a server group. The router device 3 can be a router, a switch, or a gateway device.

As shown in FIG. 1, each router device 3 includes a number or ports P.

As shown in FIG. 2, each transmission path control device 1 includes a communication unit 11, a processor 12, and a storage unit 13.

The communication unit 11 is used to communicate the management server 2 via the corresponding network, and is used to communicate with the communication unit 11 of another the transmission path control device 1. The communication unit 11 can be a network card, a WIFI module, a telephone card, or the like.

The storage unit 13 stores a port topology file of the corresponding router device 3 connected to the path control device 201. The port topology file includes different areas directed by different ports P of the router device 3. In the embodiment, each area directed by one port P of the router device 3 is the area that another router device 3 connects to the router device 3 via the corresponding port P is located in.

The processor 12 is used to run a path calculating module 121 and a path determining module 122.

In the embodiment, the path calculating module 121 and the path determining module 122 can be collections of software instructions stored in the storage unit 13 of the transmission path control device 1 and executed by the processor 12 of the transmission path control device 1. The path calculating module 121 and the path determining module 122 also can include functionality represented as hardware or integrated circuits, or as software and hardware combinations, such as a special-purpose processor or a general-purpose processor with special-purpose firmware.

In one embodiment, the processor 12 can be a central processing unit, a digital signal processor, or a single chip, for example. In one embodiment, the storage unit 13 can be an internal storage system, such as a flash memory, a random access memory (RAM) for temporary storage of information, and/or a read-only memory (ROM) for permanent storage of information. The storage unit 13 can also be a storage system, such as a hard disk, a storage card, or a data storage medium. The storage unit 13 can include volatile and/or non-volatile storage devices. In at least one embodiment, The storage unit 13 can include two or more storage devices such that one storage device is a memory and the other storage device is a hard drive. Additionally, one or more of the storage units 13 can be respectively located either entirely or partially external relative to the transmission path control device 1.

The path calculating module 121 is used to determine whether there is one port P of the corresponding router device 3 connected to the transmission path control device 1 is directed to an end area according to the port topology file of the router device 3 when the transmission path control device 1 receives a virtual lease line (VLL) establishing request including a VLL identifier and a start area and the end area of the VLL. If not, namely if there is no port P of the router device 3 is directed to the end area, the path calculating module 121 transmits the VLL establishing request to a default transmission path control device 1. The path calculating module 121 of the default transmission path control device 1 executes the function as described above. Namely, the path calculating module 121 of the default path control device 1 determines whether there is one port P of a default router device 3 connected to the default path control device 1 is directed to the end area. If not, the path calculating module 121 of the default transmission path control device 1 transmits the VLL establishing request to another default transmission path control device 1. Therefore, the path calculating module 121 executes the above steps repeatedly, until the path calculating module 121 determines one port P of one router device 3 connected to the current transmission path control device 1 is directed to the end area.

The path calculating module 121 further determines which router devices 3 are transmission nodes constituting the VLL and determines which ports P are ports to be connected to another port of the router devices 3 determined as the transmission nodes constituting the VLL and generates VLL establishing information including connection relationships of the router device 3 determined as the transmission nodes of the VLL and the ports P to be connected. In the embodiment, the path calculating module 121 determines the router devices 3 connected to the transmission path control devices receiving the VLL establishing request as the transmission nodes constituting the VLL. The path calculating module 121 determines the ports P directed to the area the default router device 3 locates and the port P directed to the end area as the ports P to be connected.

In the embodiment, the path calculating modules 121 of the transmission path control devices 1 are communicated to each other and share the VLL establishing information. In another embodiment, the path calculating module 121 of each transmission path control device 1 receiving the VLL establishing request sends a determination result of determining whether one port P of the corresponding router device 3 is directed to the end area to the path calculating module 121 of the transmission path control device 1 located in the start area when the transmission path control device 1 receiving the VLL establishing request determines there is one port P is directed to the end area or not.

The path establishing module 122 is used to label the ports P to be connected the router devices 3 determined as the transmission nodes constituting the VLL by using the VLL identifier, and connect the ports P labeled with the VLL identifier one by one, thus to establish the VLL. In detail, the path establishing module 122 connects the adjacent ports P labeled with the VLL identifier one by one to establish the VLL.

In the embodiment, when the transmission path control device 1 is located in the start area, the path establishing module 122 of the transmission path control device 1 further connects the terminal device 100 to the VLL in response to an operation of the user to connect to the transmission path control device 1 located in the start area via the terminal device 100 of the user. In detail, the path establishing module 122 connects the terminal device 100 of the user to the router device 3 connected to the transmission path control device 1 located in the start area, thus to connect the terminal device 100 to the VLL.

When the transmission path control device 1 is located in the end area, the path establishing module 122 of the transmission path control device 1 further connects the router device 3 located in the end area to a target object 200, thus to establish the connection between the router device 3 located in the end area and the target object 200. Therefore, the terminal device 2 of the user can access the target object 200 via the VLL. In the embodiment, the VLL establishing request further includes information of the target object 200 (e.g., an Internet protocol address of the target object 200) that the user requests to access, the path establishing module 122 of the transmission path control device 1 determines the target object 200 according to the information of the target object 200, and connects the router device 3 located in the end area to the target object 200.

In the embodiment, the target object 400 can be another terminal device 100 or a network, such as a private network, Internet, for example.

In the embodiment, the VLL establishing request further includes information of a bandwidth, a start time, and an end time of the VLL. The path establishing module 122 further assigns the corresponding bandwidth to the VLL when establishing the VLL, and controls to establish the VLL only during the start time and the end time.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission path control device comprising:
a communication unit configured to connect to a router device located in a same area as the transmission path control device and other transmission path control devices located in other areas via corresponding networks;
a storage unit configured to store a port topology file of the router device connected to the transmission path control device and a plurality of modules which are collections of instructions, the port topology file comprising different areas directed by different ports of the router device; and
at least one processor configured to execute the plurality of modules, the plurality of modules comprising:
a path calculating module configured to determine whether there is one port of the router device connected to the transmission path control device that is directed to an end area according to the port topology file of the router device when the transmission path control device receives a virtual lease line (VLL) establishing request comprising a VLL identifier and a start area and the end area of the VLL, wherein if no port of the router device is directed to the end area, the path calculating module transmits the VLL establishing request to a default transmission path control device, if one port of the router device is directed to the end area, the path calculating module determines which router devices are transmission nodes constituting the VLL and determines which ports are ports to be connected to another port of the router devices determined as the transmission nodes constituting the VLL, and generates VLL establishing information comprising connection relationships of the router device determined as the transmission nodes of the VLL and the ports to be connected; and
a path establishing module configured to label the ports to be connected by using the VLL identifier, and connect the ports labeled with the VLL identifier one by one to establish the VLL.

2. The transmission path control device according to claim 1, wherein when the transmission path control device is located in the start area, the path establishing module of the transmission path control device further connects a terminal device to the VLL in response to an operation of the user to connect to the transmission path control device located in the start area via the terminal device of the user.

3. The transmission path control device according to claim 2, wherein the path establishing module connects the terminal device of the user to the router device connected to the transmission path control device located in the start area, thus to connects the terminal device to the VLL.

4. The transmission path control device according to claim 1, wherein when the transmission path control device is located in the end area, the path establishing module of the transmission path control device further connects the router device located in the end area to a target object, thus to establish the connection between the router device located in the end area and the target object.

5. The transmission path control device according to claim 4, wherein the target object is a terminal device or a network comprising a private network or Internet.

6. The transmission path control device according to claim 1, wherein the VLL establishing request further comprises information of a bandwidth, a start time, and an end time of the VLL, the path establishing module further assigns the corresponding bandwidth to the VLL when establishing the VLL, and controls to establish the VLL only during the start time and the end time.

7. The transmission path control device according to claim 1, wherein the transmission path control device is a personal computer or a server.
